(19) United States
(12) Patent Application Publication
(10) Pub. No.: US 2010/0145089 A1
(43) Pub. Date: Jun. 10, 2010

(54) PREPARATION OF (POLY)SULFIDE ALKOXYSILANES AND NOVEL INTERMEDIATES THEREFOR

(76) Inventors: Gérard Mignani, Lyon (FR); Samir Mansouri, Valencin (FR); Samuel Arthaud, Mornant (FR)

Correspondence Address: BUCHANAN, INGERSOLL & ROONEY PC, POST OFFICE BOX 1404, ALEXANDRIA, VA, 22313-1404, US

(21) Appl. No.: 12/514,167

(22) PCT Filed: Nov. 9, 2007
(86) PCT No.: PCT/EP2007/062166

§ 371 Date: Nov. 18, 2009

(30) Foreign Application Priority Data
Nov. 10, 2006 (FR) 0609836

(51) Int. Cl. C07F 7/18

(52) U.S. Cl. 556/429; 556/427

(57) ABSTRACT

At least one polythio alkoxy and/or halosilane is/are prepared by reacting at least one sulfur-containing reagent (Rs) with at least one alkoxy and/or halosilane; intermediates therefor include the thio alkoxy and/or halosilanes of formula

(CH₃CH₂O)(Me)₂Si—(CH₂)₃—S—CO—(CH₂)₅—CH₃.

The invention relates to a new synthesis pathway for (poly)sulfide alkoxy- and/or halosilanes.

The target end products are, more specifically, alkoxydisilanes in which the two alkoxy silane units are connected to one another by a (poly)sulfide bridge. These alkoxysilanes may be useful in particular as white filler/elastomer coupling agents in elastomer compositions comprising a white filler, in particular a siliceous substance, as a reinforcing filler.

Coupling agents, especially silica/elastomer coupling agents, have been described in a large number of documents, the best-known of these agents being difunctional organoxysilanes which carry at least one organoxysilyl function and at least one function capable of reacting with the elastomer, such as, in particular, a polysulfide functional group.

Patent application WO-A-02/083719 describes polysulfide monoorganooxysilanes with a linking propylene unit, of formula F:

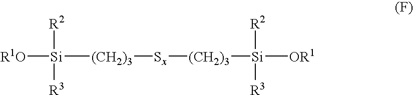

in which the symbols R₁, R₂, and R₃ are monovalent hydrocarbon groups and x is a number ranging from 3±0.1 to 5±0.1. These compounds can be used as white filler/elastomer coupling agents in diene rubber compositions comprising a white filler such as a siliceous substance as a reinforcing filler.

U.S. Pat. No. 5,780,661 describes a process for preparing methyldichlorosilanes functionalized with a sulfur radical. This process consists in reacting allyldichloromethylsilane with a sulfur reactant of the thiophenol, N-propylmercaptan or thioacetic acid type by a free-radical mechanism in the presence of an azobisisobutyronitrile initiator in a reaction chamber under inert gas by heating at 60° C. for 4 to 5 hours.

In this context, one of the key objectives of the present invention is to provide an alternative pathway to alkoxy- and/or halosilanes, especially polysulfide monoalkoxysilanes, more particularly those as defined by the above formula (F).

Another key objective of the invention is that this alternative synthesis pathway should be simple and economic to exploit.

These objectives, among others, are achieved by the present invention, which firstly provides a process for preparing at least one (poly)sulfide alkoxy- and/or halosilane, characterized
in that it consists essentially in reacting at least one sulfur reactant (Rs) with at least one alkoxy- and/or halosilane of formula (I):

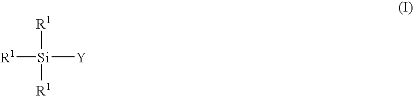

in which:
the symbols R¹, which are identical or different, each represent:
   a linear, branched or cyclic alkyl radical having 1 to 20 carbon atoms;
   an aryl radical having 6 to 18 carbon atoms;
   an alkoxy radical —OR², with R² corresponding to a linear, branched or cyclic alkyl radical having 1 to 20 carbon atoms or an aryl radical having 6 to 18 carbon atoms;
   an arylalkyl radical or an alkylaryl radical (C₆-C₁₈ aryl, C₁-C₆ alkyl);
   a hydroxyl radical (—OH);
   or a halogen, preferably chlorine;
      at least one of these radicals R¹ being —OR², —OH or a halogen, and, moreover, these radicals R¹, when they are neither hydroxyls nor halogens, optionally carrying at least one halogen-containing group;
the symbol Y represents a monovalent organic functional group preferably selected from “sensitive” functional groups R³ containing at least one ethylenic and/or acetylenic unsaturation, in particular selected from:
   linear, branched or cyclic alkenyl groups R^{3.1} having 2 to 10 carbon atoms,
   linear, branched or cyclic alkynyl groups R^{3.2} having 2 to 10 carbon atoms,
   linear, branched or cyclic -(alkenyl-alkynyl) or -(alkynyl-alkenyl) groups R^{3.3} having 5 to 20 carbon atoms,
the radicals R^{3.1} being particularly preferred,
   and it being possible for Y, additionally, optionally to comprise at least one heteroatom and/or to carry one or more aromatic groups;
with the proviso that, where at least two of the radicals R¹ each correspond to a halogen, the reaction mixture is (virtually) free of free-radical initiator(s).

The invention secondly provides sulfide alkoxy- and/or halosilanes capable of being intermediates in the process according to the invention as defined above, of formula (III):

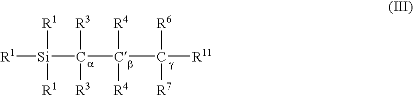

in which:
the symbols R¹, which are identical or different, each represent:
   a linear, branched or cyclic alkyl radical having 1 to 20 carbon atoms;
   an aryl radical having 6 to 18 carbon atoms;
   an alkoxy radical —OR², with R² corresponding to a linear, branched or cyclic alkyl radical having 1 to 20 carbon atoms or an aryl radical having 6 to 18 carbon atoms;
   an arylalkyl radical or an alkylaryl radical (C₅-C₁₈ aryl, C₁-C₂₀ alkyl);
   a hydroxyl radical (—OH);
   or a halogen, preferably chlorine;
      at least one of these radicals R¹ being —OR², —OH or a halogen, at least one of these radicals R¹ not being —OR² (preferably one and only one of these radicals R¹ being —OR²), and, moreover, these radicals R¹, when they are neither hydroxyls nor halogens, optionally carrying at least one halogen-containing group;
the symbols R³ and R⁴, which are identical or different to one another, each represent hydrogen or a monovalent hydrocarbon group selected from a linear, branched or cyclic alkyl radical having 1 to 20 carbon atoms and a linear, branched or cyclic alkoxyalkyl radical having 1 to 20 carbon atoms,
the symbols R⁶ and R⁷, which are identical or different to one another, each represent hydrogen or a monovalent hydrocarbon group selected from a linear, branched or cyclic alkyl radical having 1 to 20 carbon atoms and a linear, branched or cyclic alkoxyalkyl radical having 1 to 20 carbon atoms,
the symbol R¹¹ represents —S—CO—R⁸, —SCS—R⁸, —SR⁸, —SCS—NR⁸₂ or —SCS—OR⁸, with R⁸ corresponding to:
a linear, branched or cyclic alkyl radical having 1 to 20 carbon atoms, preferably a methyl;
an aryl radical having 6 to 18 carbon atoms, preferably a phenyl;

an acyl radical —R¹⁰—CO—OR⁸, with R¹⁰ representing an alkylene having 1 to 20 carbon atoms, preferably a methylene;
a hydroxyalkyl radical having 1 to 20 carbon atoms, preferably a hydroxyethyl;
or an arylalkyl radical or an alkylaryl radical (C₆-C₁₈ aryl, C₁-C₆ alkyl);
   it being possible for these radicals R⁸ to carry at least one halogen-containing group.

### First Subject Of The Invention

It is to the merit of the inventors to have provided a new synthesis pathway which is radically different from the synthesis pathways known for the preparation of polysulfide alkoxysilanes, which involve reacting at least one alkoxysilane with sulfide reactants.

In contrast to this the invention proposes reacting an alkoxy- and/or halosilane (I) which is functionalized, preferably with an alkenyl function, for example having a terminal allyl moiety, with a sulfur reactant (Rs), in particular in the absence of free-radical initiator.

The new pathway according to the invention is based on a free-radical addition mechanism which is easy to implement and is economic.

(Rs) and (I) react in such a way that a free-radical addition mechanism is involved.

Moreover, entirely surprisingly and unexpectedly, this free-radical addition mechanism is (virtually) spontaneous. It does not require activation, whether by addition of free-radical initiator(s) and/or actinic activation (photonic activation: for example, tank under UV lamp, particularly HP Hg lamp) and/or thermal and/or ultrasonic activation and/or by electron bombardment.

It is nevertheless entirely possible, according to one version of the invention, to provide for such activation.

With reference to the activation by means of free-radical initiator(s), this is prohibited, in accordance with the invention, where at least two of the radicals R¹ each correspond to a halogen. In this context it should be specified that the expression “the reaction mixture is (virtually) free of free-radical initiator(s)” signifies in particular that the reaction mixture does not contain free-radical initiator or contains only traces of free-radical initiator(s), in other words in an amount which is insufficient to give rise to activation of the free-radical reaction (for example, less than or equal to 0.1% by weight).

Where at least two of the radicals R¹ are each different from a halogen, it is possible, but not vital, to employ at least one free-radical initiator.

Similarly, actinic activation (photonic activation: for example, tank under UV lamp, particularly HP Hg lamp) and/or thermal and/or ultrasonic activation and/or by electron bombardment may be employed. In practice it is preferred to employ thermal activation, which generally involves heating the reaction mixture to a temperature between ambient temperature and 120° C., preferably between 50 and 110° C., for standard atmospheric pressure.

This new synthesis pathway is simple and unrestrictive from an industrial standpoint.

Preferably the silane of formula (I) is such that at least one (more preferably only one) of the radicals R¹ is —OR².

The (poly)sulfide alkoxysilanes and halosilanes obtained by the process according to the invention advantageously comprise a polysulfide unit [S]ₓ.

According to one preferred feature of the invention, Y corresponds to the formula (II) below:

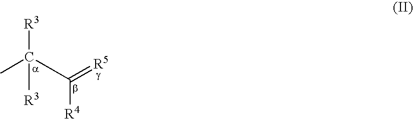

in which:
the symbols R³ and R⁴, which are identical or different to one another, each represent hydrogen or a monovalent hydrocarbon group selected from a linear, branched or cyclic alkyl radical having 1 to 20 carbon atoms and a linear, branched or cyclic alkoxyalkyl radical having 1 to 20 carbon atoms,
the symbol R⁵ represents —CH₂ or —CR⁶R⁷, with the symbols R⁶ and R⁷, which are identical or different to one another, each representing hydrogen or a monovalent hydrocarbon group selected from a linear, branched or cyclic alkyl radical having 1 to 20 carbon atoms and a linear, branched or cyclic alkoxyalkyl radical having 1 to 20 carbon atoms, methyl being particularly preferred.

Preferably the (free-radical) addition of (Rs) is on the gamma (γ) carbon of the alkoxy- and/or halosilane (I).

In a particularly advantageous and surprising way, the addition according to the invention to this terminal alkenyl moiety Y of formula (II) of the silane (I) enjoys a high total regioselectivity and a high isolated yield, of greater than 90%, for example; this total regioselectivity signifies that the double bond of the radical Y reacts with the sulfur reactant (Rs) without secondary reaction.

The alkoxy- and/or halosilane of formula (I) that is used in the process according to the invention may be obtained by reacting at least one halo- and/or alkoxysilane with at least one halogenated organic compound, preferably an allyl halide, in the presence of at least one metal selected from the group consisting of Mg, Na, Li, Ca, Ba, Cd, Zn, Cu, mixtures thereof, and alloys thereof (preferably magnesium), in the presence of an ethereal organic solvent and/or an acetal solvent, by a mechanism based on the Barbier reaction.

Another pathway for synthesizing the starting alkoxy- and/or halosilane of formula (I) may be a more traditional pathway, in particular in which a trialkoxysilane and/or a trihalosilane functionalized with a haloalkyl group is employed, by a Grignard reaction mechanism involving a halomagnesium Grignard reagent, namely MeMgCl. This synthesis pathway is described in particular in patent applications JP-A-2002179687 and WO-A-03/027125.

According to another advantageous embodiment of the process according to the invention, the sulfur reactant (Rs) is selected from the group consisting of H₂S, HS—CO—R⁸, HSR⁸, HSCSR⁸, HSCS—NR⁸₂, HSCS—OR⁸, and mixtures thereof, the symbol R⁸ corresponding to:
a linear, branched or cyclic alkyl radical having 1 to 20 carbon atoms, preferably a methyl;
an aryl radical having 6 to 18 carbon atoms, preferably a phenyl;
an acyl radical —R¹⁰—CO—OR⁹, with R⁹ corresponding to the same definition as that given for R⁸, R¹⁰ representing an alkylene having 1 to 20 carbon atoms, preferably a methylene;
a hydroxyalkyl radical having 1 to 20 carbon atoms, preferably a hydroxyethyl;
or an arylalkyl radical or an alkylaryl radical (C₆-C₁₈ aryl, C₁-C₂₀ alkyl);
it being possible for R⁸ to be a divalent cyclic radical including the atom to which it is bonded (for example C, S or N);
R⁸ and R¹⁰ optionally carrying at least one halogen-containing or perhalogenated group.

These reactants (Rs) are economic and readily available. Thus the above reactants (Rs) are described in the very extensive literature relating to thiols, and, for example, in U.S. Pat. No. 5,780,661.

The (free-radical) addition reaction of the silane of formula (I) with these reactants (Rs) leads to intermediate compounds which are thiols when (Rs) corresponds to HSH or mercaptan derivatives having terminal moieties —S—CO—R⁸, —SR⁸, —SCS—R⁸, —SCS—NR⁸₂ or —SCS—OR⁸ when (Rs) corresponds to HS—CO—R⁸, HSR⁸, HSCS—R⁸, HSCS—NR⁸₂ or HSCS—OR⁸, respectively.

According to one variant embodiment (V1) in which (Rs) corresponds to HS—CO—R⁸, HSR⁸, HSCS—R⁸, HSCS—NR⁸₂ or HSCS—OR⁸, the product from the reaction between (I) and (Rs) is reacted with at least one transesterification/amidation reagent (Rt) allowing conversion of the thioester having a terminal moiety —S—CO—R⁸, —SR⁸, —SCS—R⁸, —SCS—NR⁸₂ or —SCS—OR⁸ to a thiol function —SH. (Rt) is selected from the group of reagents capable of reacting by a mechanism of nucleophilic addition to the carbon of the thioester function, preferably from the group consisting of alcohols (for example, ethanol), amines (for example, ammonia), preferably primary amines, hydrogen sulfide, and mixtures thereof.

If (Rt) is an alcohol, the reaction is a transesterification; if (Rt) is an amine, the reaction is a transamidation.

Especially in the case where a reagent (Rt) is used that is selected from alcohols, this transesterification may be carried out in the presence of at least one base, preferably selected from the group consisting of carbonates (advantageously K₂CO₃ or Na₂CO₃), phosphates (advantageously K₃PO₄), alkoxides (advantageously CH₃CH₂ONa), and mixtures thereof.

According to a variant embodiment (V2), in which (Rs) corresponds to HS—CO—R⁸, HSCS—R⁸, HSCS—NR⁸₂ or HSCS—OR⁸, the silane (I) is reacted with the sulfur reactant (Rs) so as to join the terminal radical R⁵ of the group Y of the silane (I) to a terminal moiety —S—CO—R⁸, —SCS—R⁸, —SCS—NR⁸₂ or —SCS—OR⁸. The resulting intermediate is reacted with HSH to convert the terminal moiety —S—CO—R⁸—SCS—R⁸, —SCS—NR⁸₂ or —SCS—OR⁸ to a thiol function —SH and so to produce a thiol intermediate, while reconstituting (Rs), which hence plays the part of a relay molecule.

The reaction scheme below illustrates, without limitation, the variant V2 with a relay molecule

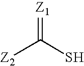

in which Z₁ may correspond to O and Z₂ to —OR² with R² as defined above.

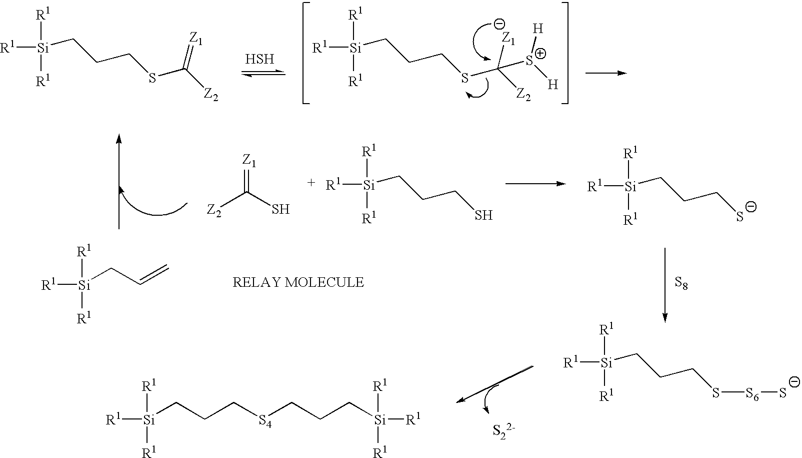

This relay molecule can be used in situ. For example, for H—SCOCH₃, it is possible to carry out beforehand the reaction between acetic anhydride and H₂S:

CH₃—CO—O—CO—Me+H₂S→H—S—COCH₃+HO—COCH₃, or the reaction between NaHS and ClCOCH₃.

In accordance with the invention it is possible to prepare specified polysulfide alkoxysilanes, namely alkoxydisilanes or bisalkoxysilanes, in which the alkoxysilyl units are joined to one another by a sulfur bridge containing one or more sulfur atoms.

To do this it is appropriate to employ the thiol intermediate obtained directly by reaction of the silane (I) with a reactant (Rs) corresponding to HSH, or indirectly by reaction of the silane (I) with a reactant (Rs) corresponding to HS—CO—R⁸, HSCS—R⁸, HSCS—NR⁸₂ or HSCS—OR⁸, then with the transesterification reagent (Rt) in accordance with variant (V1), or with HSH in accordance with variant V2.

This thiol intermediate is advantageously reacted with a secondary sulfur reactant (Rs2) selected from the group consisting of Sₓ and/or X1S—SX2, with the symbol x corresponding to a whole or fractional number ranging in general from 1 to 10, preferably from 1 to 5, and more preferably from 1.5 to 5, in particular between 3 and 5, for example between 3.5 and 4.5, the end points of these ranges being accurate to +/−0.2, and X1 and X2 representing independently a halogen, preferably chlorine, this secondary sulfidation being advantageously carried out in a basic medium comprising as base, for example, K₂CO₃, Na₂CO₃, K₃PO₄, (CH₃CH₂)ONa or mixtures thereof.

In addition to the qualitative aspects relating to the nature of the silane (I) and of the sulfur reactant (Rs), the process according to the invention also integrates advantageous quantitative aspects. Thus the molar (I)/(Rs) ratio is in particular between 5 and 0.1, preferably between 3 and 0.5, and more preferably between 2 and 0.7.

According to one variant, the reaction between (Rs) and (I) (free-radical addition) in the process according to the invention may be carried out under an inert atmosphere and/or, optionally, with the aid of at least one free-radical initiator, such as azobisisobutyronitrile (AIBN), for example.

Advantageously the process according to the invention comprises at least one step of hydrolysis allowing at least one of the radicals R¹ that corresponds to —OR² of the (poly)sulfide alkoxy- and/or halosilane to be converted to a silanol.

The products obtained by the process according to the invention that are specifically targeted are polysulfide disilanes (or bis-silanes) comprising polysulfide alkoxysilanes and/or halosilanes of formula (IV):

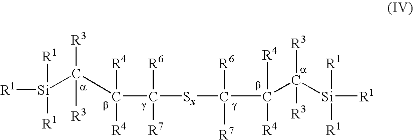

in which:
the symbols R¹, which are identical or different, each represent:
   a linear, branched or cyclic alkyl radical having 1 to 20 carbon atoms;
   an aryl radical having 6 to 18 carbon atoms;
   an alkoxy radical —OR², with R² corresponding to a linear, branched or cyclic alkyl radical having 1 to 20 carbon atoms or an aryl radical having 6 to 18 carbon atoms;
   an arylakyl radical or an alkylaryl radical (C₆-C₁₈ aryl, C₁-C₂₀ alkyl)
   a hydroxyl radical (—OH);
   or a halogen, preferably chlorine;
at least one of these radicals R¹ being —OR², —OH or a halogen, and, moreover, these radicals R¹, when they are neither hydroxyls nor halogens, optionally carrying at least one halogen-containing group;
the symbols R³ and R⁴, which are identical or different to one another, each represent hydrogen or a monovalent hydrocarbon group selected from a linear, branched or cyclic alkyl radical having 1 to 20 carbon atoms and a linear, branched or cyclic alkoxyalkyl radical having 1 to 20 carbon atoms,
the symbols R⁶ and R⁷, which are identical or different to one another, each represent hydrogen or a monovalent hydrocarbon group selected from a linear, branched or cyclic alkyl radical having 1 to 20 carbon atoms and a linear, branched or cyclic alkoxyalkyl radical having 1 to 20 carbon atoms,
the symbol x corresponds to a whole or fractional number which is in general between 1 and 10, preferably between 1 and 5, and more preferably between 1.5 and 5, in particular between 3 and 5, for example between 3.5 and 4.5, the end points of these ranges being accurate to +/−0.2.

More particularly, two of the substituents R¹ of at least one of the two terminal silicons are alkyl radicals, preferably methyl, ethyl, n-propyl, isopropyl, n-butyl, CH₃O—CH₂— or CH₃O—CH(CH₃)CH₂— (for example, methyl, ethyl, n-propyl or isopropyl), or aryl radicals, for example phenyl, these two substituents R¹ being preferably methyls; the third substituent R¹ is preferably an alkoxy —OR², preferably with R² corresponding to methyl, ethyl, n-propyl, isopropyl, n-butyl, CH₃O—CH₂— or CH₃O—CH(CH₃)CH₂— (for example, methyl, ethyl, n-propyl or isopropyl).

More particularly the polysulfide disilanes preferably obtained by the process according to the invention correspond to the formula (IV.1):

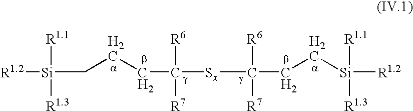

in which:
the symbols R^{1.1}, R^{1.2}, and R^{1.3}, which are identical or different to one another, correspond to one of the definitions given above for R¹; R^{1.1}, and R^{1.3} correspond preferably to an alkyl (advantageously methyl or ethyl) and R^{1.2} corresponds preferably to an alkoxy (advantageously methoxy or ethoxy);
the symbols R⁶ and R⁷, which are identical or different to one another, each represent hydrogen or a monovalent hydrocarbon group selected from an ethyl or methyl radical; R⁶ and R⁷ each correspond preferably to hydrogen.

The alkoxysilanes corresponding to the formula (IV.1) which are especially targeted by the present invention are those for which:

R^{1.1} and R^{1.3} each represent a methyl and
R⁶ and R⁷ represent a hydrogen, and
radicals R¹⁻², which are identical, each represent a methoxy, an isopropyl or, preferably, an ethoxy, and the symbol x corresponds to a whole or fractional number between 1.5 and 5, in particular between 3 and 5, advantageously between 3.5 and 4.5, the end points of these ranges being given to an accuracy of +/−0.2.

The process according to the invention is directed in particular to the preparation of alkoxysilanes corresponding to formula (IV.1) in which R^{1.1} and R^{1.3} each represent a methyl, R⁶ and R⁷ represent a hydrogen, radicals R^{1.2}, which are identical, each represent an ethoxy, and the symbol x corresponds to a whole or fractional number between 3 and 5, advantageously between 3.5 and 4.5, the end points of these ranges being given to an accuracy of +/−0.2.

The symbol x in the formulae (IV) and (IV.1) is a whole or fractional number which represents the number of sulfur atoms present in a molecule of formula (IV) or (IV.1).

This number may be an exact number of sulfur atoms, where the synthesis pathway of the compound in question is able to give rise to only one variety of polysulfide product.

In practice this number tends to be the average of the number of sulfur atoms per molecule of compound in question, in so far as the synthesis pathway selected generally tends to give rise to a mixture of polysulfide products each having a different number of sulfur atoms. In that case the polysulfide compounds synthesized are in fact composed of a distribution of polysulfides, ranging from the monosulfide or the disulfide S₂ to heavier polysulfides (for example S_{≧5}), centered on an average molar value (value of the symbol x) which is situated within the general ranges referred to above. Advantageously the polysulfide mono-organoxysilanes synthesized are composed of a distribution of polysulfides comprising a molar figure of (S₃+S₄) of greater than or equal to 40% and, preferably, greater than or equal to 50%; and of (S₂+S_{≧5}) of less than or equal to 60% and, preferably, less than or equal to 50%. Moreover, the molar proportion of S₂ is advantageously less than or equal to 30% and, preferably, less than or equal to 20%. All of the limit values are given to the accuracy of measurement (by NMR), with an absolute error of approximately ±1.5 (for example 20±1.5% for the last proportion indicated).

Some of the polysulfide compounds obtained with the process according to the invention, especially the alkoxysilanes containing a polysulfide bridge connecting two alkoxysilane residues, more particularly those of formula (IV), preferably of formula (IV.1), can be used as a white filler/elastomer coupling agent in compositions comprising at least one diene elastomer and a white filler (especially a precipitated silica) as a reinforcing filler, said compositions being intended, for example, for the manufacture of diene elastomer articles.

### Second Subject Of The Invention

The new synthesis pathway proposed in the first subject of the invention, as described above, is highly advantageous in particular in that it leads to new sulfide alkoxy- and/or halosilanes which are intermediates. In its second subject, the invention is therefore directed to these new sulfide alkoxysilanes and/or halosilanes, whether or not they are intermediates in the process in accordance with the first subject of the invention.

These new sulfide alkoxy- and/or halosilane products are products of above-defined formula (III).

In one preferred embodiment of the sulfide alkoxy- and/or halosilanes of formula (III), two of the substituents R¹ are alkyl radicals, preferably methyl, ethyl, n-propyl, isopropyl, n-butyl, CH₃O—CH₂— or CH₃O—CH(CH₃)CH₂—(for example, methyl, ethyl, n-propyl or isopropyl), or aryl radicals, for example phenyl, these two substituents R¹ being preferably methyls; the third substituent R¹ is preferably an alkoxy —OR², in particular with R² corresponding to methyl, ethyl, n-propyl, isopropyl, n-butyl, CH₃O—CH₂— or CH₃O—CH(CH₃)CH₂—(for example, methyl, ethyl, n-propyl or isopropyl).

The products of formula (III) which are especially targeted by the present invention are sulfide alkoxysilanes, more particularly sulfide alkoxysilanes of formula (III.1):

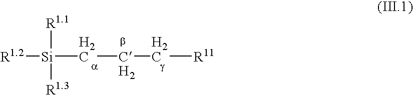

in which the symbols R^{1.1}, R^{1.2} and R^{1.3}, which are identical or different to one another, correspond to one of the definitions given above for R¹; R¹¹ being as defined above (in formula (III)); R^{1.1} and R^{1.3} corresponding preferably to an alkyl (advantageously methyl or ethyl), and R^{1.2} corresponding preferably to an alkoxy (advantageously methoxy or ethoxy).

One such example of sulfide alkoxysilane is a compound of formula (III.1.1):

(CH₃CH₂O)(Me)₂SI—(CH₂)₃—S—CO—(CH₂)₅—CH₃ (III.1.1)

The examples which follow illustrate the invention, but without limiting its scope.

### EXAMPLES

### Reaction in γ Position

### Example 1

A 10 ml reactor is charged under argon with 1.00 g (6.94 mmol) of allyldimethylethoxysilane and 0.8 g (7.17 mmol) of HS—CH₂—CO₂Et. This charge is left to react at 100° C. for 16 hours. GC analysis shows a degree of conversion of more than 98%.

The product is the ethyl ester of [3-(ethoxydimethylsilanyl)propylsulfanyl]acetic acid. The addition derivative is obtained with a virtually quantitative yield and a regioselectivity of more than 99%.

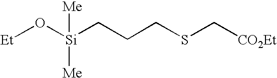

### Example 2

A 10 ml reactor is charged under argon with 1.01 g (7.02 mmol) of allyldimethylethoxysilane and 0.55 g (7.04 mmol) of 2-mercaptoethanol. This charge is left to react at 60° C. for 16 hours. The degree of conversion of the starting materials is complete. The structural analyses show that the reaction mass is composed very primarily (>90 mol %) of the following derivative:

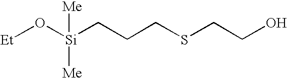

The regioselectivity is greater than 99%.

### Example 3

A 10 ml reactor is charged under argon with 1.00 g (6.96 mmol) of allyldimethylethoxysilane and 0.81 g (6.96 mmol) of cyclohexyl mercaptan. This charge is left to react at 60° C. for 16 hours. The degree of conversion of the starting materials is complete. The structural analyses show that the reaction mass is composed very primarily (>80 mol %) of the following derivative:

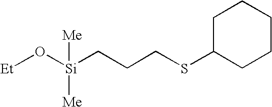

The regioselectivity is greater than 99%.

### Example 4

A 10 ml reactor is charged under argon with 1.08 g (7.57 mmol) of allyldimethylethoxysilane and 1.18 g (7.70 mmol) of thiobenzoic acid. This charge is left to react at 60° C. for 16 hours. The degree of conversion of the starting materials is complete. The structural analyses show that the reaction mass is composed very primarily (>75 mol %) of the following derivative:

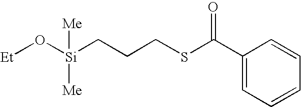

The regioselectivity is greater than 99%.

### Example 5

A 10 ml reactor is charged under argon with 1.08 g (7.57 mmol) of allyldimethylethoxysilane and 7.60 mmol of thioacetic acid. This charge is left to react at 60° C. for 16 hours. The degree of conversion of the starting materials is complete. The structural analyses show that the reaction mass is composed very primarily (>75 mol %) of the following derivative:

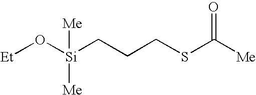

The regioselectivity is greater than 99%.

### Example 6

### Synthesis of (CH₃CH₂O)Si(CH₃)₂—CH₂—CH₂—CH₂—S—C(O)—CH₃

Addition of thioacetic acid to dimethylethoxyallyl-silane under air

A 100 ml three-necked flask with a condenser, a temperature probe, an oil bath, and a magnetic stirrer is charged with the following under air:
20.01 g of dimethylallylsilane (allyldimethylethoxy-silane) (139 mmol)
10.8 g of thioacetic acid (139 mmol).

This charge is heated at 60° C. for 3 hours. The degree of conversion is greater than 99% (GC analysis).

30.5 g of a colorless liquid are recovered.

The ¹H and ¹³C NMR analyses confirm the structure of the product formed:

(CH₃CH₂O)Si(CH₃)₂—CH₂—CH₂—CH₂—S—C(O)—CH₃

with a purity of greater than 95 mol % and a virtually quantitative yield.

### Example 7

### Hydrolysis of the thioester obtained in example 6 by ethanol—Synthesis of the gamma thiol from the thioacetic ester

A 50 ml round-bottomed flask with magnetic stirrer is charged under argon with 8.08 g of 3-(ethoxydimethylsilyl)propylthioacetic ester (36.7 mmol, 1 eq.), 1.08 g of potassium carbonate (7.82 mmol, 0.21 eq.), and 40 ml of absolute ethanol degassed with argon (686 mmol, 18.67 eq.).

The reaction mixture is left with stirring at 70° C. for 3 hours. The degree of conversion is 100%. The reaction mixture is then filtered under an inert atmosphere, evaporated, and distilled under vacuum.

This gives a distillation fraction containing 98% of thiol of interest and of mass m of 5.58 g of product, or an isolated yield of 85%.

The structural analyses confirm the formation of the following product:

CH₃CH₂O(CH₃)₂Si—(CH₂)₃—SH

### Example 8

### Hydrolysis of the thioester obtained in example 6 with ammonia—Synthesis of the gamma thiol from the thioacetic ester

In a Schlenk with guard tube and magnetic stirrer and a bubbling tube with frit.

20 ml of absolute ethanol degassed with argon (340 mmol, 38 eq.) and 2.00 g of 3-(ethoxydimethyl-silyl)propylthioacetic (9.13 mmol, 1 eq.) are introduced.

The ammonia is released and is bubbled in gently and as required.

The hydrolysis reaction is exothermic. The degree of conversion becomes complete after 8 hours.

The reaction mixture is then evaporated in order to remove the ethanol, and the residue is taken up in pentane and filtered; the filtrate is then evaporated. This gives a colorless mobile oil with a strong thiol odor and a mass m of 1.64 g.

The yield is virtually quantitative.

Structural analysis confirms the presence of the following compound, with a molar purity of greater than 75%:

CH₃CH₂O(CH₃)₂Si—(CH₂)₃—SH

The secondary product is the acetamide.

The yield is therefore 90%.

### Example 9

### Synthesis of (CH₃CH₂O)Si(CH₃)₂—CH₂—CH₂—CH₂—Sₓ—CH₂—CH₂—CH₂—Si(CH₃)₂(OCH₃CH₂)

In a 25 ml three-necked flask with a condenser, a temperature probe, a cold bath, and magnetic stirring, the following are introduced under argon:
ml of anhydrous tetrahydrofuran
1.0062 g of (CH₃CH₂O) Me₂Si(CH₂)₃SH
589 mg of anhydrous triethylamine.

The reaction mixture is cooled to 0° C. 387 mg of sulfur dichloride (Cl₂S₂) are run in over 5 minutes. The reaction is highly exothermic and the temperature of the reaction mixture climbs to 10° C. It is kept with vigorous stirring for 15 minutes and then left to return to ambient temperature. The salts formed are isolated by filtration, washed with pentane and evaporated to dryness.

This gives a yellow oil with a mass of 1.21 g, with a quantitative weight yield.

The ¹H and ¹³C NMR analyses confirm the structure of the product formed:

(CH₃CH₂O)Si(CH₃)₂—CH₂—CH₂—CH₂—Sₓ—CH₂—CH₂—CH₂

—Si(CH₃)₂(OCH₃CH₂)

and allow the following to be ascertained: average M of 399.6 g.mol⁻¹, with an average number x of 3.4.

### Example 10

### Synthesis of (CH₃CH₂O)(CH₃)₂Si—(CH₂)₃—S—CO—(CH₂)₆—CH₃

In a strictly dry 25 ml single-necked flask with condenser and oil bath, and under air, 1.0182 g (1.02 mmol) of n-thiooctanoic acid (1 molar equivalent) and 667.7 mg (1.00 mmol) of ethoxydimethylallylsilane (1 molar equivalent) are introduced. The mixture is stirred at 60° C. For 48 hours, the reaction is monitored by gas chromatography. The reaction mixture is left to cool and a mobile yellow oil is recovered (with a mass m of 1.045 g) of the derivative

(CH₃CH₂O)(CH₃)₂Si—(CH₂)₃—S—CO—(CH₂)₆—CH₃, of which the NMR and IR analyses confirm the structure.

### Example 11

In a 40 ml Hastelloy reactor, under autogenous pressure, with magnetic stirrer and oil bath, and under an argon atmosphere, 2.0 g of (3-propylethoxydimethyl-allylsilane)thioacetic ester (8.91 mmol, 1 eq.) and 1.34 g of polysulfane (9.23 mmol, 1.04 eq.) are introduced. The two liquids are not miscible.

The reactor is closed and the reaction mixture is heated at 150° C. for 16 hours with stirring.

It is left to cool and then the reactor is opened. It contains a liquid mixed with sulfur. The reactor contents are filtered to give an oil with a mass m of 3.47 g, with a yield of 93%.

NMR and IR analyses confirm the formation of the derivative

CH₃CH₂O(CH₃)₂Si—(CH₂)₃—Sx—(CH₂)₃—Si(CH₃)₂OCH₂CH₃ with an average number x of 4.

### Example 12

In a 40 ml Hastelloy reactor, under autogenous pressure, with magnetic stirrer and oil bath, and under an argon atmosphere, 2.05 g of ethoxydimethylallyl-silane (13.90 mmol, 1 eq.), 967 mg of flowers of sulfur (30.2 mmol, 2.17 eq.) and 4.3 ml of anhydrous isopropanol (56.2 mmol, 4.04 eq.) are introduced. The solid and liquid reactants are not miscible.

The reactor is closed and the reaction mixture is heated at 150° C. for 16 hours with stirring.

It is left to cool and then the reactor is opened. It contains a liquid mixed with sulfur. The reactor contents are filtered to give an oil with a mass m of 3.78 g, with an isolated yield of 65%.

NMR and IR analyses confirm the formation of the derivative

CH₃CH₂O(CH₃)₂Si—(CH₂)₃—Sₓ(CH₂)₃—Si(CH₃)₂OCH₂CH₃, with an average number x of 4.

### Example 13

An 80 ml Hastelloy reactor pelletized at the upper limit of useful pressure of 200 bar, with a magnetic stirrer and resistance heater, is charged under an argon atmosphere with 30 g of ethoxydimethylallylsilane (208 mmol, 1 eq.). 28 bar of H₂S are added.

The reactants are brought together; the H₂S pressure is maintained constant during the operation, by successive additions of gas.

The reaction mixture is heated from ambient temperature to 150° C. over 20 hours, followed by a plateau at 150° C. for 15 hours.

At the end of the reaction, the temperature is lowered to ambient temperature again and the remaining H₂S is degassed. The degree of conversion is approximately 30%.

The reaction mixture is subsequently distilled under vacuum. This gives a mass of 10.9 g of a distillation fraction with a purity of greater than 95%.

The structural analyses confirm the addition of the hydrogen sulfide in gamma position.

### Example 14

In a 40 ml Hastelloy reactor, under autogenous pressure, with magnetic stirrer and oil bath, and under an argon atmosphere, 820 mg of 3-thiopropyl-ethoxydimethylsilane (4.60 mmol, 1 eq.) and 271 mg of flowers of sulfur (8.46 mmol, 1.84 eq.) are introduced. The solid and liquid reactants are not miscible.

The reactor is closed and the reaction mixture is heated at 150° C. for 16 hours with stirring.

It is left to cool and then the reactor is opened. It contains an orange liquid mixed with sulfur. The reactor contents are filtered to give an oil with a mass m of 838 mg, with a yield of 87%.

The oil contains virtually exclusively the following product:

CH₃CH₂O(CH₃)₂Si—(CH₂)₃—Sₓ—(CH₂)₃—Si(CH₃)₂OCH₂CH₃, with an average number x of 4.

### Example 15

A perfectly dry 25 ml three-necked flask under argon, equipped with a condenser, temperature probe, magnetic stirrer, and cold bath, is charged with the following in this order:
ml of anhydrous THF (185 mmol, 33 eq.)
1.00 g of 3-thiopropylethoxydimethylsilane (5.65 mmol, 1 eq.)
790 μl of anhydrous triethylamine (5.64 mmol, 1 eq.)
230 μl of sulfur chloride (2.81 mmol, 0.5 eq.).

From the start of the introduction of the first drops of Cl—S—S—Cl, the reaction mass, which was clear, becomes turbid, with formation of a white precipitate with a slight yellow tinge. The reaction is exothermic and the introduction is made over 30 minutes.

At the end of the introduction, the reaction mixture is heterogeneous and orange-yellow; it is filtered on a number 4 frit; the filtrate is evaporated, then taken up in pentane, filtered again, and sucked dry.

This gives a mass m of 1.21 g of a clear, mobile yellow oil, with a yield of 97%.

The structural analyses confirm the presence of the following product, with a molar purity of greater than 97%:

CH₃CH₂O(CH₃)₂Si—(CH₂)₃—Sₓ—(CH₂)₃—Si(CH₃)₂OCH₂CH₃, with an average number x of 3.7.

1.-17. (canceled)

18. A process for preparing at least one (poly)sulfide alkoxy- and/or halosilane, comprising:
reacting at least one sulfur reactant (Rs) with at least one alkoxy- and/or halosilane of formula (I): 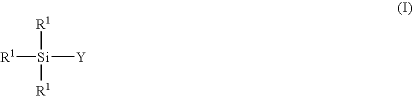
in which:
the symbols R¹, which may be identical or different, are each a linear, branched or cyclic alkyl radical having 1 to 20 carbon atoms, an aryl radical having 6 to 18 carbon atoms an alkoxy radical —OR², wherein R² is a linear, branched or cyclic alkyl radical having 1 to 20 carbon atoms or an aryl radical having 6 to 18 carbon atoms, an arylalkyl radical or an alkylaryl radical (C₆-C₁₈ aryl, C₁-C₂₀ alkyl), a hydroxyl radical, or a halogen,
at least one of these radicals R¹ being —OR², —OH or a halogen, and such radicals R¹, when they are neither hydroxyls nor halogens, optionally bear at least one halogen-containing substituent;
the symbol Y is a monovalent organic functional group, optionally a functional group R³ containing at least one site of ethylenic and/or acetylenic unsaturation, optionally selected from among:
linear, branched or cyclic alkenyl radicals R^{3.1} having 2 to 10 carbon atoms,
linear, branched or cyclic alkynyl radicals R^{3.2} having 2 to 10 carbon atoms,
linear, branched or cyclic -(alkenyl-alkynyl) or -(alkynyl-alkenyl) radicals R^{3.3} having 5 to 20 carbon atoms,
with the proviso that Y may optionally comprise at least one heteroatom and/or to bear one or more aromatic substituents; and
with the further proviso that, where at least two of the radicals R¹ are each halogen, the reaction mixture is essentially free of free-radical initiator(s).

19. The process as defined by claim 18, wherein the reaction of (Rs) and (I) is carried out in the absence of free-radical initiator.

20. The process as defined by claim 18, wherein at least one of the radicals R¹ is —OR².

21. The process as defined by claim 18, wherein Y has the formula (II) below: 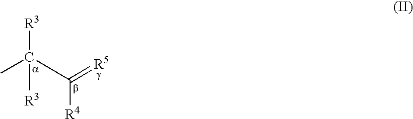
in which:
the symbols R³ and R⁴, which may be identical or different, are each hydrogen or a monovalent hydrocarbon group selected from among a linear, branched or cyclic alkyl radical having 1 to 20 carbon atoms or a linear, branched or cyclic alkoxyalkyl radical having 1 to 20 carbon atoms;
the symbol R⁵ is —CH₂ or —CR⁶R⁷, wherein the symbols R⁶ and R⁷, which may be identical or different, are each hydrogen or a monovalent hydrocarbon radical selected from among a linear, branched or cyclic alkyl radical having 1 to 20 carbon atoms and a linear, branched or cyclic alkoxyalkyl radical having 1 to 20 carbon atoms.

22. The process as defined by claim 21, comprising an addition of (Rs) to the gamma carbon of the group Y of the formula (II) of the silane (I).

23. The process as defined by claim 18, wherein the (I)/(Rs) molar ratio ranges from 5 to 0.1.

24. The process as defined by claim 18, wherein (Rs) is selected from among HSH, HS—CO—R⁸, HSR⁸, HSCSR⁸, HSCS—NR⁸₂, HSCS—OR⁸, and mixtures thereof, and the symbol R⁸ is:
a linear, branched or cyclic alkyl radical having 1 to 20 carbon atoms,
an aryl radical having 6 to 18 carbon atoms,
an acyl radical —R¹⁰—CO—OR⁹, wherein R⁹ has the same definition as that for R⁸ and R¹⁰ is an alkylene radical having 1 to 20 carbon atoms,
a hydroxyalkyl radical having 1 to 20 carbon atoms,
or an arylalkyl radical or an alkylaryl radical (C₆-C₁₈ aryl, C₁-C₂₀ alkyl);
with the proviso that R⁸ may be a divalent cyclic radical including the atom to which it is bonded; and
R⁸ and R¹⁰ optionally bearing at least one halogen-containing or perhalogenated radical.

25. The process as defined by claim 24, wherein (Rs) is HS—CO—R⁸, HSR⁸, HSCS—R⁸, HSCS—NR⁸₂ or HSCS—OR⁸, and the product from the reaction of (I) and (Rs) is reacted with at least one transesterification/amidation reagent (Rt) allowing conversion of the terminal moiety —S—CO—R⁸, —SR⁸, —SCS—R⁸, —SCS—NR⁸₂ or —SCS—OR⁸ of the thioester to a thiol function —SH, to provide an intermediate thiol, (Rt) being selected from among reagents capable of reacting by a mechanism of nucleophilic addition to the carbon of the thioester function, optionally selected from the group consisting of alcohols, amines, hydrogen sulfide, and mixtures thereof.

26. The process as defined by claim 24, wherein:
(Rs) is HS—CO—R⁸, HSCS—R⁸, HSCS—NR⁸₂ or HSCS—OR⁸;
the silane (I) is reacted with the sulfur reactant (Rs) to join the terminal radical R⁵ of the group Y of the silane (I) to a terminal moiety —S—CO—R⁸, —SCS—R⁸, —SCS—NR⁸₂ or —SCS—OR⁸; and
the resulting intermediate is reacted with HSH to convert the terminal moiety —S—CO—R⁸, —SCS—R⁸, —SCS—NR⁸₂ or —SCS—OR⁸ to a thiol function —SH to produce a thiol intermediate, while reconstituting (Rs).

27. The process as defined by claim 24, wherein the thiol intermediate obtained is reacted with a secondary sulfur reactant (Rs2) selected from the group consisting of Sₓ and/or X1S—SX2, in which the symbol x is a whole or fractional number ranging from 1 to 10, the end points of such range being accurate to +/−0.2, and X1 to X2 are independently a halogen, this secondary sulfidation being carried out in a basic medium comprising as base, K₂CO₃, Na₂CO₃, K₃PO₄, (CH₃CH₂)ONa or mixtures thereof.

28. The process as defined by claim 18, wherein the reaction of (Rs) and (I) is carried out under an inert atmosphere and/or with the aid of at least one free-radical initiator.

29. The process as defined by claim 18, comprising at least one step of hydrolysis permitting at least one of the radicals R¹ that corresponds to —OR² of the (poly)sulfide alkoxy- and/or halosilane to be converted to a silanol.

30. A sulfide alkoxy- and/or halosilane of formula (III): 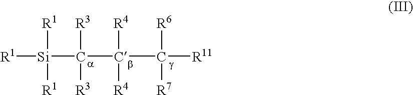
in which:
the symbols R¹, which may be identical or different, are each:
a linear, branched or cyclic alkyl radical having 1 to 20 carbon atoms,
an aryl radical having 6 to 18 carbon atoms,
an alkoxy radical —OR², wherein R² is a linear, branched or cyclic alkyl radical having 1 to 8 carbon atoms or an aryl radical having 6 to 18 carbon atoms,
an arylalkyl radical or an alkylaryl radical (C₆-C₁₈ aryl, C₁-C₂₀ alkyl),
a hydroxyl radical,
or a halogen, at least one of such radicals R¹ being —OR², —OH or a halogen, at least one of such radicals R¹ not being —OR², and such radicals R¹, when they are neither hydroxyls nor halogens, optionally bearing at least one halogen-containing substituent;
the symbols R³ and R⁴, which may be identical or different, are each hydrogen or a monovalent hydrocarbon radical selected from among a linear, branched or cyclic alkyl radical having 1 to 20 carbon atoms and a linear, branched or cyclic alkoxyalkyl radical having 1 to 20 carbon atoms;
the symbols R⁶ and R⁷, which may be identical or different, are each hydrogen or a monovalent hydrocarbon radical selected from among a linear, branched or cyclic alkyl radical having 1 to 20 carbon atoms and a linear, branched or cyclic alkoxyalkyl radical having 1 to 20 carbon atoms;
the symbol R¹¹ is —S—CO—R⁸, —SCS—R⁸, —SR⁸, —SCS—NR⁸₂ or —SCS—OR⁸, wherein R⁸ is:
a linear, branched or cyclic alkyl radical having 1 to 8 carbon atoms,
an aryl radical having 6 to 18 carbon atoms,
an acyl radical —R¹⁰—CO—OR⁸, wherein R¹⁰ is an alkylene radical having 1 to 8 carbon atoms,
a hydroxyalkyl radical having 1 to 8 carbon atoms,
or an arylalkyl radical or an alkylaryl radical (C₆-C₁₈ aryl, C₁-C₂₀ alkyl), with the proviso that such radicals R⁸ may bear at least one halogen-containing substituent.

31. The sulfide alkoxy- and/or halosilane as defined by claim 30, having the formula (III) in which only one of the substituents R¹ is an alkoxy radical —OR².

32. The sulfide alkoxy- and/or halosilane as defined by claim 30, having the formula (III) in which two of the substituents R¹ are alkyl radicals, CH₃O—CH₂— or CH₃O—CH(CH₃)CH₂—, or aryl radicals, and the third substituent R¹ is an alkoxy —OR², wherein R² is methyl, ethyl, n-propyl, isopropyl, n-butyl, CH₃O—CH₂— or CH₃O—CH(CH₃)CH₂—.

33. The sulfide alkoxysilane as defined by claim 30, having the formula (III.1): 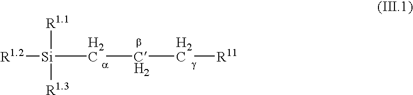
in which the symbols R^{1.1}, R^{1.2}, and R^{1.3}, which may be identical or different, are each one of the definitions given for R¹, R^{1.1} and R^{1.3.}

34. The sulfide alkoxysilane as defined by claim 33, having the formula (III.1.1):
(CH₃CH₂O)(Me)₂Si—(CH₂)₃—S—CO—(CH₂)₅—CH₃
